(19) United States
(12) Patent Application Publication
(10) Pub. No.: US 2016/0236993 A1
(43) Pub. Date: Aug. 18, 2016

(54) Method of Making Functionalized Nanoporous Structures

(71) Applicant: Lybradyn, Inc., Oak Brook, IL (US)

(72) Inventors: John Aikens, La Grange Park, IL (US); John C. Parker, Naperville, IL (US)

(21) Appl. No.: 15/044,546

(22) Filed: Feb. 16, 2016

Related U.S. Application Data
(60) Provisional application No. 62/116,149, filed on Feb. 13, 2015.
(60) Provisional application No. 62/116,151, filed on Feb. 13, 2015.

(51) Int. Cl. C04B 38/04; A01N 59/16; B05D 3/00; A01N 25/26

(52) U.S. Cl. CPC C04B 38/04; A01N 25/26; A01N 59/16; B05D 3/007

(57) ABSTRACT

A functionalized nanoporous structure comprising: (a) a matrix that comprises a first sol-based ceramic; and (b) one or more functionalized nanosized pores within the matrix, wherein each functionalized nanosized pore is defined by (i) a coating that comprises a second sol-based ceramic and, optionally, a first functional material; and (ii) a second functional material bound to the coating, wherein the second functional material is optional if the coating comprises the first functional material; and (c) optionally, a hybrid component that comprises one or more particles of a composition different from that of the matrix.

### CROSS-REFERENCE TO RELATED APPLICATIONS

This application is a U.S. Non-provisional application claiming the benefit of U.S. Provisional Application 62/116,149, filed Feb. 13, 2015, and U.S. Provisional Application 62/116,151, filed Feb. 13, 2015, each of which is incorporated herein by reference in its entirety.

### FIELD OF THE INVENTION

The present invention is directed to the preparation of nanoporous structures using a templating method.

### BACKGROUND OF INVENTION

The peer reviewed literature and patents disclose numerous examples of defined structures prepared by templating methods. In each of these examples a variety of defined structures have been employed to create an imprint upon a substrate prior to removal of the templating agent. An important feature of such templates is the facility by which they may be removed. Typically, templates are removed by degradation of the material of the template. For example, polystyrene microspheres that form defined pores in a membrane or monolithic ceramics and glasses may be readily removed by thermal treatment of the substrate material to decompose the microspheres. In addition to solid templates, foaming agents have been introduced into materials to afford pores created from entrapped bubbles.

There are numerous drawbacks to these conventional techniques. For example, subjecting the substrate or matrix to significant changes in temperature, pressure, and/or relatively aggressive chemical environments in order to decompose templates often results undesirable changes to the characteristics of the substrate/matrix material. Additionally, such removals and use of foaming agents often result in relatively non-uniform void structures. Still further, the substrate/matrix may retain residues from the template that alter the function or physical characteristics of the substrate. For example, template removal rarely allows for the substrate/matrix to maintain chemical functionality within the inner surface of the substrate vacated by the template. In addition, template defined materials are often prepared using expensive templates or labor intensive multi-step procedures that limit final applications to high value-added products and have precluded widespread industrial use. In fact, the use of templates has been so costly and/or burdensome that many defined structural materials are manufactured using self-assembly of substrate materials that define and commonly determine the final structure of the material (e.g., synthetic zeolites).

In view of the foregoing, a need exists for an adaptable and versatile method for preparing well-defined, cost-effective template prepared materials.

### SUMMARY OF INVENTION

In one embodiment, the present invention is directed to a method of making a functionalized nanoporous structure from a templated matrix, wherein the templated matrix comprises:
(i) the matrix, which comprises a matrix component that comprises a first sol-based ceramic;
(ii) one or more nanosized templates within the matrix, wherein each nanosized template comprises a ZnO core and a coating on the core, wherein the coating comprises a second sol-based ceramic and, optionally, a first functional material; and
(iii) optionally, a hybrid component that comprises one or more particles of a composition different from that of the matrix within the matrix;
   and the method comprises:
contacting the templated matrix with an acid solution to dissolve the ZnO core(s) and form one or more nanosized pores, each of which being defined by the coating; and
contacting the coating(s) defining the nanosized pore(s) with a composition comprising a second functional material to bind all or a portion of the second functional material to the coating(s) defining the nanosized pore(s), wherein the contacting the coating(s) defining the nanosized pore(s) with the composition comprising the second functional material is optional if the coating(s) comprise(s) the first functional material;
   thereby forming the functionalized nanoporous structure, which comprises the (a) matrix, (b) one or more functionalized nanosized pores within the matrix, wherein each functionalized nanosized pore is defined by the coating and, optionally, the second functional material, and (c) optionally, the hybrid component within the matrix.

In another embodiment, the present invention is directed to a functionalized nanoporous structure produced by the foregoing method.

In yet another embodiment, the present invention is directed to a functionalized nanoporous structure comprising:

a matrix that comprises a first sol-based ceramic; and

one or more functionalized nanosized pores within the matrix, wherein each functionalized nanosized pore is defined by (i) a coating that comprises a second sol-based ceramic and, optionally, a first functional material; and (ii) a second functional material bound to the coating, wherein the second functional material is optional if the coating comprises the first functional material; and

optionally, a hybrid component that comprises one or more particles of a composition different from that of the matrix.

### BRIEF DESCRIPTION OF THE DRAWINGS

FIG. 1 is a schematic of an embodiment of the present invention in which a ZnO template is coated with a silicate and then ZnO template is dissolved to yield a silicate shell or a functionalized silicate shell.

FIG. 2 is a schematic of an embodiment of the present invention in which ZnO templates are set in a silicate matrix or functionalized silicate matrix and then the ZnO templates are dissolved to yield a silicate or functionalized silicate structure with nanosized voids.

FIG. 3 is a schematic of an embodiment of the present invention in which functionalized coated ZnO templates are set in a silicate matrix or a functionalized silicate matrix and then the ZnO templates are dissolved leaving the functionalized coating that was coated on the ZnO templates defining nanosized void structures in the matrix.

FIG. 4 is a photographic comparison showing the difference in the binding of anionic molecules (i.e., Coomassie Brilliant Blue dye dissolved in water) to silicate shells having quartenary amine functionalized interior surfaces and those without functionalized interior surfaces.

FIG. 5 is a photographic comparison of a fluorescein functional group tagged mesoporous silica monolith (on the left) and a non-tagged mesoporous silica monolith (on the right), wherein fluorescence emission was observed by illuminating the samples with UV light.

FIG. 6 is a schematic-chemical formula diagram of a void/pore surface with a polysiloxane linked 2,6-diethyl-4-hydroxyethylphenyliminopyridine ligand.

FIG. 7 is a schematic-chemical formula diagram of a void/pore surface with a polysiloxane linked triphenylphosphine ligand.

FIG. 8 is a photographic comparison of P. fluorescens challenged with silver treated silicates in with clearing zones (antibacterial activity) are indicated by areas of no active bacterial growth surrounding specified samples. The data reflected in FIG. 6 are summarized in Table A.

### DETAILED DESCRIPTION OF INVENTION

Historically, nanomaterials have been considered value added products dictated by the preparation and processing methods that are low yielding or costly. In addition very few nanomaterials can be degraded without leaving residues under mild conditions. The method of the present invention addresses these concerns and allows for the product of nanoporous structures in a relatively low cost and readily implementable manner. Further, this method may be performed without significantly degrading or negatively affecting the matrix or the formed voids or pores. Still further, in certain embodiments, the method may be performed to produce functionalized nanoporous structures having one or more nanosized pores that are functionalized.

Specifically, the method of the present invention is directed to making a functionalized nanoporous structure from a templated matrix, wherein the templated matrix comprises (i) a matrix that that is selected from a group consisting of an organic polymer, a sol-based ceramic, an aluminum salt, an organoaluminate, an aluminosilicate, and combinations thereof and (ii) one or more nanosized templates within the matrix, wherein each nanosized template comprises a core that comprises an inorganic oxide. The method comprises contacting at least a portion of the templated matrix with an acid solution to dissolve at least a portion of the inorganic oxide of at least one of the cores and form the at least one nanosized pore within the matrix thereby forming the nanoporous structure.

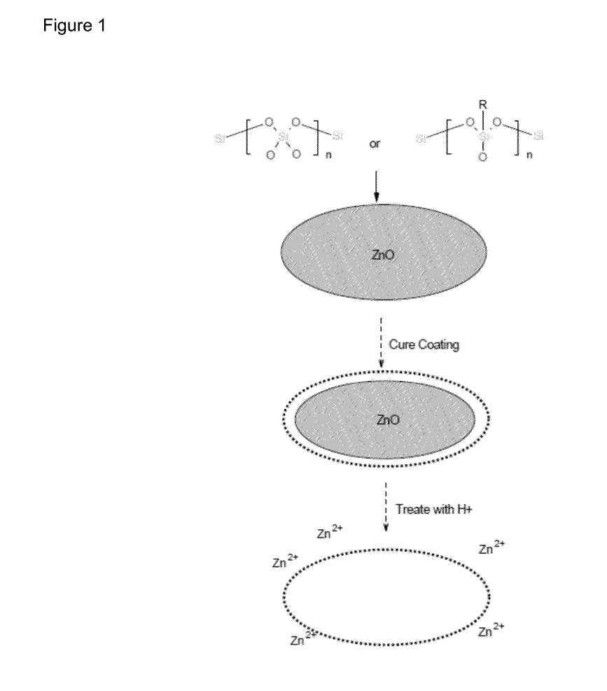

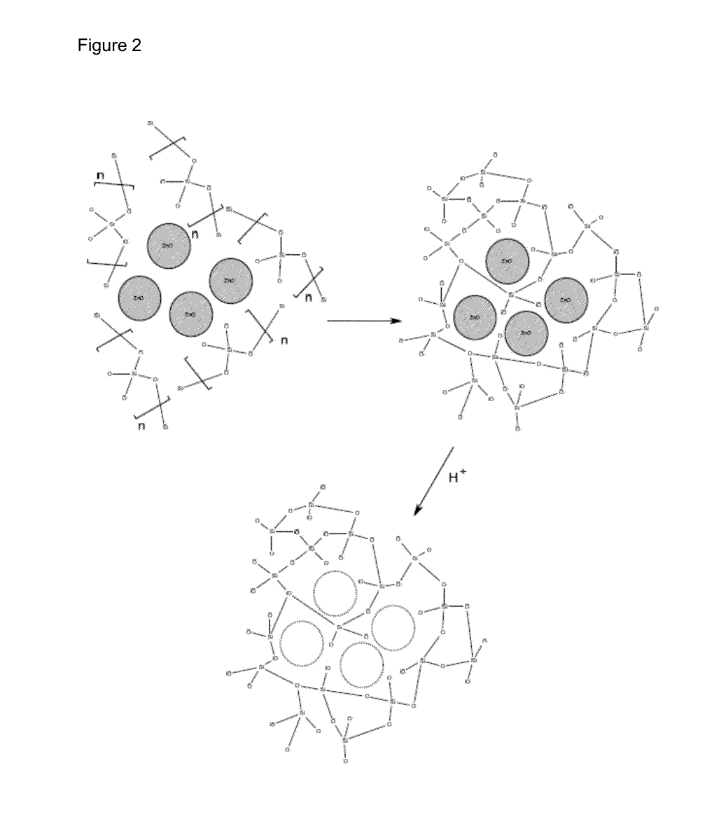

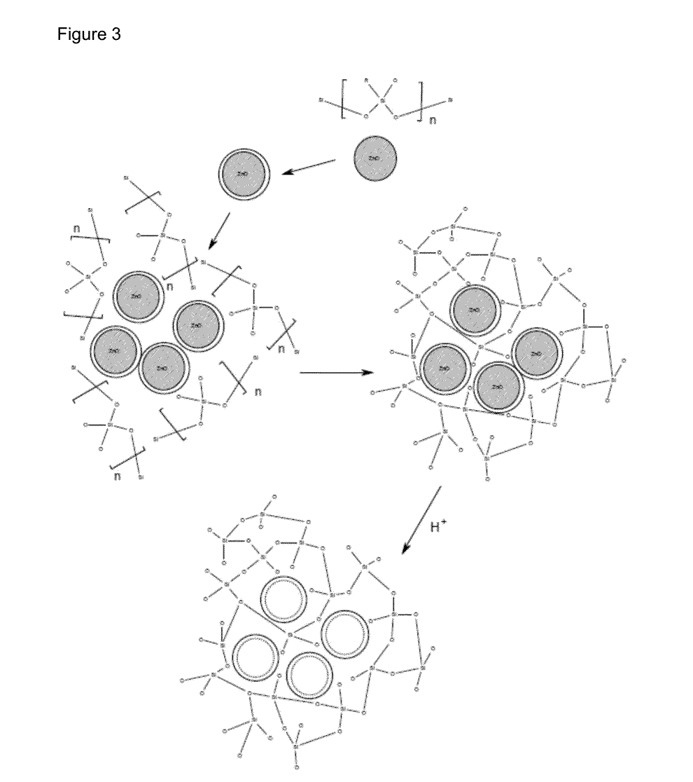

Advantageously, the above-described method and the materials allow for significant flexibility with regard to the type and characteristics of the formed nanoporous structure. For example, in one embodiment of the present invention the nanoporous structure is a shell such as depicted in FIG. 1. Described differently, such a shell is an individual hollow particle in which the shell is the matrix and the pore or void therein is the result of dissolving the inorganic oxide of a nanosized template. Alternatively, in other embodiments of the present invention the nanoporous structure is a monolith or a film such as depicted in FIG. 2. Still further, the aforementioned shells, monoliths, and films have a pore/void or pores/voids (as the case may be) that are functionalized such as depicted in FIG. 3. In yet another embodiment, the aforementioned shells, monoliths, and films have one or more surfaces that are functionalized and one or more pores/voids (as the case may be) that are not functionalized, which may be useful for the production of a thin film of functionalized matrix having a controlled porosity imparted by the dissolution of the templates. Still further, such a thin film may comprise multiple layers of differently functionalized matrix material(s). In still another embodiment, the aforementioned shells, monoliths, and films have one or more surfaces that a functionalized and the one or more pores/void (as the case may be) that are also functionalized.

### I. TEMPLATES

### A. Cores

As indicated above, a template comprises at least a core and the core comprises an inorganic oxide. In certain embodiments the template consists of the core. In certain embodiments, the core consists of the inorganic oxide.

### B. Inorganic Oxide

The aforementioned benefits and flexibility are based, in part, on the material(s) selected for the templates. Nanoparticles comprising and/or consisting of inorganic oxide are readily available and certain inorganic oxides nanoparticles are available for a relatively low cost while still allowing for a significant degree of freedom with respect to size and shape, the selection of which allows for a degree of customization depending upon the particular desired application. In certain embodiments, the inorganic oxide is selected from the group consisting of FeₓO_{y}, ZnO, SnO₂, CaO, SiO₂ and combinations thereof. In certain embodiments, the inorganic oxide is ZnO. Additionally, in certain embodiments, the templates may be of the same composition or the templates may be of different compositions (e.g., particles comprising different oxide(s) or particles comprising the same oxides at different relative amounts or concentration levels).

Zinc oxide is often selected because nanoparticles comprising or consisting of zinc oxide are generally commercially available at a relatively low cost, in particular compared to other inorganic oxides. Such nanoparticles are often prepared by a physical vapor synthesis (PVS) process, which is a relatively high yield, low cost process that produced high quality material. Additionally, the PVS process allows for the particle size distribution to be controlled for a particular application specifications (e.g., from narrow to broad primary particle size distributions) without adding significant cost to the nanomaterial.

Advantageously, ZnO particles are hydrophilic and are easily wet by or dispersed in aqueous liquids/solutions used to form the matrix (i.e., liquid matrix precursor described in greater detail below). But if it is desired for ZnO particles to be wet by or dispersed in non-aqueous liquids/solutions, this is also readily accomplished because ZnO particles may be surface treated to impart this characteristic with, for example, a compatibilizer coating (described in greater detail below). Further, ZnO is considered to be thermally stable and tolerant to many solvents, excluding solutions comprising mineral acids in which it is considered to be highly soluble. It is this characteristic that allows ZnO nanoparticles (depending upon the size) to be readily removed from a matrix under relatively mild acidic conditions such that the matrix tends not to be negatively affected (e.g., attacking the matrix or leaving undesirable residues). Still further, ZnO has been found to be labile with respect to extremes in pH (i.e., it is freely soluble below a pH 2 and above a pH 10 and is converted to Zn⁺² ions). Additionally, results to date show that no significant residual ZnO or Zn⁺² ions remain in the matrix after it is dissolved and the matrix is appropriately washed and/or soaked. In view of the foregoing, nanoparticulate zinc oxide tends to be an attractive template to create defined nanoporous voids in a wide variety of materials.

### C. Size of Cores

The cores may be of essentially any size(s) and/or of a size distribution(s) appropriate for a desired application. As used herein, the term “size,” with respect to nanoparticles, means nanoparticles able to pass through a sieve opening of that size. Sieve openings are square in shape and the size of the opening corresponds to the length of a side. For example, a spherical nanoparticle having a diameter less than 40 nm is able to pass through a 40 nm sieve opening. Similarly, a nanoparticle that is a rod having a length greater than 40 nm having and a diameter less than 40 nm is able to pass through a 40 nm sieve opening.

In certain embodiments, the core(s) used to make particular nanoporous structure(s) may be of relatively uniform size or have a relatively narrow particle size distribution (e.g., the particles have a mean size and at least about 80% of the particles are within about ±40% of the mean). In other embodiments, the core(s) used to make particular nanoporous structure(s) may be of a relatively broad particle size distribution (e.g., the particles have a mean size and log-normal size distribution). In still other embodiments, the core(s) used to make particular nanoporous structure(s) may be within more than one distinct particle size groups (e.g., the particles may be within two particle size groups, wherein the groups have a mean size of, e.g., 40 nm and 100 nm). Advantageously, by controlling the particle size/particle size distribution one may be able to create a nanoporous structure that is suitable for a particular application. For example, one may be able to create a nanoporous structure suitable for the controlled release of a compound such as a drug by using cores of a suitable mean size and having a relatively uniform size and/or narrow particle size distribution.

In certain embodiments, the core(s) are of a size that is less than about 500 nm. In further embodiments, the core(s) are of a size that greater than about 20 nm. In other embodiments, the core(s) are of a size that is in a range of about 20 nm to about 150 nm. In still other embodiments, the core(s) are of a size is in a range of about 30 nm to about 80 nm. To be clear, when referring to a size within a range it is intended to encompass embodiments wherein the cores of different sizes within said range and embodiments wherein the cores are of a relatively uniform size within said range.

Experimental results to date suggest that for cores consisting of ZnO of a size in the range of about 30 nm to about 80 nm, allow for relatively small pores/voids to be formed and are relatively easy to make a templated matrix but tend to be more expensive. Whereas, cores of sizes less than about 20 nm tended to be more difficult to make a templated matrix with due to the fact that they tend to be colloidal. Additionally, they are even more expensive. In contrast, ZnO nanoparticles in the size range of about 50 nm to about 500 nm tend to be significantly less costly and are also readily used to make a templated matrix. That said, experimental results to date suggest that as the size of ZnO nanoparticle cores exceeds about 50-200 nm, the cores tend to take significantly longer to completely dissolve with the acid.

### D. Shapes of Cores

The cores may be of essentially any shape appropriate for a desired application. For example, the cores may have a shape selected from the group consisting of spherical, ellipsoidal, and polyhedral. When referring to a particular shape herein, it is intended to include cores having that shape and of a configuration that is substantially the same as or similar to that shape. It is also worth noting that in any given templated matrix the cores may be of different shapes. Without being limiting, examples of polyhedral shapes include pyramid, hexahedron (cube, rhombohedron, parallelepiped, cuboid, triangular dipyramid), dodecahedron, isododecahedron, rhombic triacontahedron, elongated pentabonal cupola, octagonal prism, and square antiprism. That said, it is anticipated that the vast majority of applications will be adequately accommodated using the relatively simple and easy to manufacture spherical or spheroidal shape.

### E. Functional Coatings

In other embodiments, the template(s) comprises components in addition to the core. For example, the template(s) may comprise a functional coating on at least a portion of the core so that, upon dissolution of the at least a portion of the inorganic oxide of the core, the functional coating defines at least a portion of the corresponding nanosized pore within the matrix. In certain embodiments, the functional coating encompasses or essentially encompasses a core that consists of the inorganic oxide such that, upon dissolution of the inorganic oxide of the core, the functional coating defines all or essentially all of the nanosized pore within the matrix.

In some embodiments, the templated matrix comprises a single functionalized nanosized template. In other embodiments, the templated matrix comprises a multiplicity of functionalized nanosized templates. In still other embodiments, essentially all of the nanosized templates are functionalized.

It is also important to note that a templated matrix may comprise functionalized templates wherein the functional coatings fall into at least two distinct compositional groups (e.g., functional coatings comprising different compositions or comprising the same compounds but at different relative amounts or concentration levels). In certain embodiments, the functional coating has a thickness that is in a range of about 0.5 nm to about 2.0 nm.

Still further, a functional coating may comprise one or more layers of identical composition (i.e., the same functional material(s) at the same relative amount and/or concentration levels). Alternatively, a functional coating may comprises more than one layer in which the layers are of different composition (e.g., different materials or the same materials at different relative amounts or concentration levels). The thickness of the layer(s) may be selected as desirable and appropriate for the application.

The functional material used in the functional coating may be selected from essentially anything appropriate and desirable for a particular application. For example, the functional material selected from the group consisting of organosilianes, alkoxyorganosilanes, haloorganosilanes, polymeric organosilanes, and combinations thereof. Advantageously, by using a functional coating the pores/voids of the nanoporous structure may have organic and/or inorganic functional groups selectively assembled onto the void surface, which is believed to be heretofore unavailable feature.

Functional coatings may be applied to cores according to any appropriate method. Exemplary methods include solution phase application, high intensity dry mixing and spray/tumble mixing.

### II. SUBSTRATE/MATRIX MATERIALS

Similarly, the matrix may be formed of essentially any appropriate material for the desired application that when subjected to the acid solution is either substantially non-reactive with the acid or, if reactive, the result is desirable or does not negatively affect the matrix for the desired application. Further, the aforementioned benefits and flexibility of the method of the present invention are based, in part, on the material(s) selected for the matrix.

A. Organic Polymers

In one embodiment, the matrix comprises an organic polymer. In another embodiment, the matrix consists of one or more organic polymers. Exemplary organic polymers include polyurethanes, polyethylenes, polystyrenes, polyacrylates, alginates, polyesters, polyamides, and combinations thereof. In another embodiment, the organic polymer is selected from the group consisting of polyurethanes, alginates, polyamides, polyesters, and polyacrylates, and combinations thereof. In yet another embodiment, the organic polymer is selected from the group consisting of polyamides, alginates, polyacrylates, and combinations thereof.

In one embodiment, the matrix comprises an organic polymer selected from said exemplary organic polymers and combinations thereof. In another embodiment, the matrix consists of an organic polymer selected from said exemplary organic polymers or a combination of said exemplary organic polymers. It is to be noted that for organic polymers that tend to be hydrophobic, coatings may be added to the templates to aid in their dispersion in the matrix.

B. Sol-Based Ceramics

In one embodiment, the matrix comprises a sol-based ceramic. In another embodiment, the matrix consists of one or more sol-based ceramics. Exemplary sol-based ceramics include silicates, aluminates, aluminosilicates, titanates, and zirconates and combinations thereof. In another embodiment, the sol-based ceramic(s) is/are selected from the group consisting of silicates, aluminates, titanates, and combinations thereof. In another embodiment the sol-based ceramic(s) is/are one or more silicates. In another embodiment, the sol-based ceramic(s) is/are one or more aluminates. In yet, another embodiment, the sol-based ceramic(s) is/are a combination of one or more silicates and one or more aluminates.

1. Silicates

Exemplary silicates include silanes such alkoxysilanes, organosilanes, alkoxyorganosilanes, halosilanes, haloorganosilanes, organoalkoxysilane polymers, and combinations thereof. In another embodiment, the silicates are selected from the group consisting of silanes, halosilanes, organosilanes, alkoxyorganosilanes, alkoxysilanes, and combinations thereof. In yet another embodiment, the silicates are selected from the group consisting of alkoxyorganosilanes, alkoxysilanes, and combinations thereof. In still another embodiment, the silicates are alkoxysilanes such as but not limited to tetramethoxysilane, tetraethoxysilane and tetraproxysilane.

Silanes may be described according to chemical structure (1) below

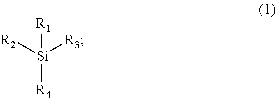

wherein R₁, R₂, R₃ and R₄ are independently selected from among alkyl, aryl, alkoxy, aryloxy, alkylether, arylether, akylester, arylester, amidoalkane, chloro, and siloxy. Preferred hydrocarbon chain lengths are 1 to about 18 carbons long. Chlorosilanes, wherein the alkoxy group in the formula above is replaced by a chlorine atom, are generally known to be more reactive to surface Si—OH groups, but are also much more reactive towards water. Thus, chlorosilanes are preferred for reaction in aprotic organic solvents but not water.

In one embodiment, the sol-based ceramic comprises one or more alkoxysilanes. Examples of appropriate alkoxysilanes include tetraethoxysilane, tetramethoxysilane, tetrapropoxysilane, and combinations thereof. Experience to date suggests that tetraethoxysilane and tetramethoxysilane may be particularly desirable depending upon the solvent system because of their relatively low cost and well understood characteristics and properties.

In one embodiment, the matrix comprises a silane selected from said exemplary silanes and combinations thereof. In another embodiment, the matrix consists of a silane selected from said exemplary silanes or a combination of said exemplary silanes.

2. Titanates

Exemplary titanates include organotitanates, halotitanates, alkoxytitanates, and combinations thereof. In another embodiment, the titanates are alkoxytitanates. Exemplary alkoxytitanates are tetraethoxytitanate, tetrabutoxytitanate, tetraisopropoxytitanate, and combinations thereof.

3. Densification

If increased densification of sol-based ceramics is desired, this may be accomplished by subjecting the material to an elevated temperature (e.g., about 150° C. or higher) to cause present organic functional groups to decompose. It is to be noted that the densified sol-based ceramic(s) are in a metastable state in which a portion of the potential reactive M-OH sites are precluded from further condensation reactions by steric bond geometry limitations and that the pores remain essentially intact upon template dissolution. Interestingly, as a result of such metastability, it is believed that the matrix comprises molecular channels in addition to the pore/voids. Such metastable matrices are believed to be very unique and with correspondingly unique structures/applications being available. Examples of such include mesoporous silica and alumina.

C. Inorganic Salts

In one embodiment, the matrix comprises one or more inorganic salts, the precursors of which include, but are not limited to, halides (e.g., chlorides and bromides), nitrates, phosphates or sulfates of silicon, aluminum and titanium, and combinations thereof. In another embodiment, the inorganic salts are selected from the group consisting of nitrates, phosphates, and sulfates of silicon, aluminum, and titanium, and combinations thereof. In yet another embodiment, the inorganic salts are selected from the group consisting of nitrates and sulfates of silicon, aluminum, and titanium, and combinations thereof.

In one embodiment, the matrix consists of one or more aluminum salts. Exemplary aluminum salts include aluminum hydroxide, aluminum nitrate, aluminum phosphate, aluminum sulfate, aluminum halides. It is worth noting that aluminum halides have limited suitability due to their reactive nature in aqueous or near aqueous solutions, which are typical for most sol-based ceramics. In some embodiments, the one or more aluminum salts are nitrate and/or sulfate salts because they tend to form stable solutions and tend to be modestly reactive under defined pH conditions. In one embodiment, the matrix comprises an aluminum salt selected from said exemplary aluminum salts and combinations thereof. In another embodiment, the matrix consists of an aluminum salt selected from said exemplary aluminum salts and combinations thereof.

D. Organoaluminates

In one embodiment, the matrix comprises an organoaluminate. In another embodiment, the matrix consists of one or more organoaluminates. Exemplary organoaluminates include aluminum tri-sec butoxide, aluminum tributoxide, aluminum triisopropoxide, aluminum tripropoxide, aluminum triethoxide, and aluminum trimethoxide. In an embodiment, the organoaluminates are aluminum trisecbutoxide and aluminum isopropoxide. In one embodiment, the matrix comprises an organoaluminate selected from said exemplary organoaluminates and combinations thereof. Although the combination of aluminum trisecbutoxide and aluminum isopropoxide are readily viable, other combinations tend to be more difficult to accommodate in a commercially significant manufacturing operation due to their reactive nature. Other combinations involving aluminum tributoxide are technically viable but, due to its cost, are generally not considered to be commercially viable. In another embodiment, the matrix consists of an organoaluminate selected from said exemplary organoaluminates and combinations thereof.

E. Combinations of Matrix Material Types

In one embodiment, the matrix is selected from a group consisting of an organic polymer, a sol-based ceramic, aluminum salt, an organoaluminate, an aluminosilicate, and combinations thereof as described in greater detail above.

### III. HYBRID MATERIALS

In one embodiment, a hybrid component is located within the matrix in addition to the template(s) or voids (as the case may be), wherein the hybrid component comprises particles of one or more compositions that is/are different from that of the matrix that may provide one or more additional properties to the matrix nanoporous structure that may be tailored depending upon the particular application. Exemplary materials for inclusion in a hybrid component include alumina, titania, fumed silica, mica, and combinations thereof. In one embodiment, the particle size(s) of the material(s) selected for inclusion in the hybrid component are independently selected to be in the range of about 50 nm to about 10 μm. In another embodiment, the particle size(s) of the material(s) selected for inclusion in the hybrid component are independently selected to be in the range of about 100 nm to about 1 μm. In yet another embodiment, the particle size(s) of the material(s) selected for inclusion in the hybrid component are independently selected to be in the range of about 100 nm to about 500 nm. Additionally, it is to be noted that the hybrid component materials may have compatibilizer coatings thereon as discussed in greater detail below.

In one embodiment, the matrix is at an amount in the range of about 15 to about 95 percent by weight of the combination of the matrix and the hybrid component, and the hybrid component is at an amount in the range of about 5 to about 85 percent by weight of the combination of the matrix and the hybrid component. In another embodiment, the matrix is at an amount in the range of about 25 to about 75 percent by weight of the combination of the matrix and the hybrid component and the hybrid component is at an amount in the range of about 25 to about 75 percent by weight of the combination of the matrix and the hybrid component.

In one embodiment, the hybrid component comprises materials having a plate-like structure such as mica. In another embodiment, the hybrid component comprises materials having an amorphous structure such as fumed silica. In another embodiment, the hybrid component comprises materials having a plate-like structure and an amorphous structure. Interestingly, it has been observed that as the relative amount of a particular type of structure hybrid material is increased in the hybrid-matrix, the physical properties of the hybrid-matrix tended to more closely resemble that of the hybrid material. In fact, in certain embodiments it has been observed that the overall structure of the hybrid-matrix may adopt the structure of the hybrid material. For example, including a relatively high amount of mica in a silicate sol-gel (e.g., 60% mica by weight) resulted in the hybrid matrix having a plate-like structure. Additionally, it was observed that the hybrid matrix comprising mica may be formulated so that the resulting nanoporous structure (after removal of the templates) may have optical properties similar to, or even essentially the same as, mica alone. Advantageously, resulting nanoporous material (i.e., after removal of the templates) allows for the binding of additional “guest” materials, molecules, elements, or compositions such as pigments, fragrances, and flavors. Of particular note, is the inclusion of pigments because that allows the nanoporous material to take on the coloration of the pigment but it optically behaves like the mica such that it has the reflectivity or pearl or opalescent look of the mica.

### IV. TEMPLATE DISSOLUTION

As indicated above, at least a portion of the inorganic oxide of at least one of the cores is dissolved with an acid solution to form the at least one nanosized pore within the matrix thereby forming the nanoporous structure. It is typically preferred for the entire of the templated matrix to be contacted with the acid solution in order optimize the efficiency of the dissolution. The acid may be contacted with the templated matrix according to any appropriate method such as spaying, immersing, or vapor treatment. Although the dissolution may be conducted in a manner such that not all of the inorganic acid of the at least one of the cores is dissolved, it is typically desirable to dissolve essentially all of the inorganic oxide of at least one of the cores and preferably of essentially all the cores in the matrix.

A wide variety of acids may be used to dissolve the inorganic oxide(s). In particular, mineral acids such as HCl, H₂SO₄, HNO₃, H₃PO₄ and combinations thereof may be used. The concentration of the acid(s) may also be within a relatively wide range of concentrations appropriate for the matrix and the template. In one embodiment, the acid is hydrochloric acid and it is at concentration in the acid solution that is in a range of about 0.05 M to about 0.5 M. Additionally, the dissolution may be accomplished by contacting the templated matrix with different solutions comprising different acids and/or of different concentrations.

Advantageously, the acid solution comprising the dissolved inorganic oxide may be collected and sold and/or used as a desirable co-product rather than being a waste. For example, the collected acid solution comprising the dissolved inorganic acid may be used to prepare a coating and/or electroplating solution comprising solute metal ions from the dissolved inorganic oxide in the collected acid solution. Specifically, such solute zinc ions may make the collected solution desirable for preparing solutions used in galvanizing.

As described in greater detail below, the matrix can be of different forms such as shells/particles/powder and consolidated structures such as monoliths and films/membranes. Experimental results to date suggest that the mesoporous matrix is the primary kinetic barrier to removing the template. As would be expected, templates in shells/particles/powders typically dissolve substantially quicker than when identically templates and matrix materials are in the form of monoliths. For example, it has been observed that templates in shells/particles/powders and films may be completely dissolved in as little as about 1 minute whereas monoliths of a maximum cross-sectional distance of about 1 centimeter have taken as long as about 3 hours to completely dissolve the templates therein.

### V. MAKING A TEMPLATED MATRIX

A templated matrix may be formed by coating the one or more nanosized templates with (or incorporating within) a liquid matrix precursor and curing the liquid matrix precursor of the coated one or more nanosized templates thereby forming the templated matrix. With respect to the coating step, any appropriate method or practice may be utilized. Examples include spraying templates with the liquid matrix precursor such as by nebulizer, or aerosol generator (paint sprayer); and mixing templates and liquid matrix precursor together with one or more types of agitation such as stirring, folding, screw mixers, ultrasonic, high shear, paddle, vortex, and pressure expansion. With respect to the curing step, it is typically advisable to allow the curing of the liquid matrix precursor to be sufficiently complete so that when the templated matrix is contacted with the acid solution the voids/pores formed by the dissolution of the inorganic acid tend to be dimensionally stable. Stated another way, it is typically desirable for the templated matrix to be cured at least to the extent that the voids/pores don't collapse.

The relative amounts of template(s) and liquid matrix precursor will depend, at least in part, on the type of contacting and the desired properties of the templated matrix and/or nanoporous structure obtained therefrom (e.g., pore-related properties such as the degree of porosity and pore size, and physical properties such as tensile, flexural, and/or compressive strength, or density, etc.). That said, experimental results to date indicate that the ratio of ZnO nanoparticles to alkoxysilane sol liquid precursor may be in the range of about 1:1000 to about 5:1 by weight.

Another factor regarding the above-described coating step is the compatibility of the template(s) and the liquid matrix precursor such that liquid matrix precursor wets the one or more nanosized templates. In certain embodiments, it is possible that the outer surface of the desired nanosized templates (e.g., the core or the functional coating) is not wet by the desired liquid matrix precursor. In that event, the nanosized templates may further comprise a compatibilizer coating that allows the liquid matrix precursor to wet the one or more nanosized templates. Exemplary compatibilizer materials for making a compatibilizer coating include organosilanes, alkoxyoranosilanes and haloorganosilanes, and combinations thereof. The compatibilizer coating may be applied to the templates by any appropriate method such as disclosed for the functional coating. In certain embodiments, the compatibilizer coating has a thickness that is in a range of about 0.1 nm to about 2 nm.

### VI. EXEMPLARY SUBSTRATE STRUCTURES

### A. Shells

As indicated above, the aforementioned methods of making a templated matrix and the nanoporous structure formed therefrom may be performed to make a variety of structure types. One such type of nanoporous structure is an individual shell or shell particles, wherein the shell comprises the matrix and, optionally, a compatibilizer coating and/or functional coating and within the shell is a nanosized pore that is formed from a templated matrix that comprises a core and, optionally, a functional coating and/or compatibilizer coating. Although the nanoporous structure is an individual shell, it is typical for a multiplicity of such shells to be made when conducting a process according to the methods set forth herein. When making such a multiplicity of shells, a multiplicity of templated matrices are typically formed by appropriate methods (e.g., precipitation, polymerized, or otherwise deposited onto surfaces of nanoparticles dispersed therein, wherein the ratio of nanosized templates to liquid matrix precursor is in a range of about 10:1 to about 100:1 by weight.

### B. Consolidated Structures

In addition to shells, the present invention may be used to form nanoporous structures that are referred to “consolidated structures” such as monoliths and films/membranes that comprise a multiplicity of nanosized pores or voids.

1. Monoliths

In the case of monoliths, the process further comprises placing the nanosized templates coated with liquid matrix precursor in a monolith mold. When making such monoliths, results indicate that the ratio of nanosized templates to liquid precursor may be in a range of about 1:100 to about 100:1 by weight.

2. Films

In the case of films/membranes, the process further comprises placing the nanosized templates coated with the liquid matrix precursor on a film-forming surface by any appropriate process such as spin coating, dip coating, spray coating, and combinations thereof.

### VII. EXEMPLARY APPLICATIONS

The methods of the present invention may be conducted to form nanoporous structures suitable for a wide variety of applications. One such application category is a controlled release agent for a compound that is, for example, a fragrance, flavor, drug, drug, pigment, etc. Current products include silica gels and b-cyclodextrins but they don't afford nanosized domains and lack discrete engineered binding elements such as functional coatings. Another application category is selective separation agent for separating liquids and gases based on, for example, size and/or chemical property. Yet another application category is catalysts and engineered functional materials.

### VIII. EXAMPLES

### A. Example 1

### Silicate Shells

Approximately 4.3 ml of ethanol (dried over 4 A molecular sieves) and 4.7 ml (21 mmol) of tetraethoxysilane were added to a round bottom flask under inert atmosphere and the solution was stirred. While continuing to stir the solution, approximately 0.262 ml deionized water was added followed by approximately 0.162 ml 0.1 M aqueous hydrochloric acid. This mixture was heated for 1.5 hours at 65° C. and the resulting sol solution was cooled to room temperature.

Approximately 8.5 ml of deionized water followed by approximately 1.5 grams of nanoparticulate zinc oxide powder obtained from Nanophase Technologies with a nominal particle size of 70 nm (15 m²/g) with vigorous stirring were added to another round bottom flask to form a slurry or dispersion. Approximately, 1.5 ml of the sol solution was added to the slurry followed by continued mixing for about 30 minutes to deposit a sol coating on the nanoparticles. Then, the slurry was centrifuged to separate the solids from the liquid. The separated solids were washed twice with a 1:1 mixture of ethanol and water to remove excess sol coating. The coated zinc oxide nanoparticles were then dispersed in 0.1 M aqueous hydrochloric acid and stirred gently for about one hour. During that time the solids became translucent. The translucent solids were separated from the liquid by centrifugation and washed two times with deionized water to remove residual acid and zinc ions.

The coating material remaining following dissolution of the template material resembles a hollow sphere that is composed of the original coating material. The shells retain roughly the shape of the nanotemplate in which the degree of shape stability depends, at least in part, upon the thickness of the coating. Generally, the thicker the original coating the more rigid the final shell and subsequently the more the shell retains the template shape.

### B. Example 2

### Silicate Monolith with Nanosized Voids

Approximately 4.3 ml of ethanol (dried over 4 A molecular sieves) and 4.7 ml (21 mmol) of tetraethoxysilane were added to a round bottom flask under inert atmosphere and the solution was stirred. While continuing to stir the solution, approximately 0.262 ml deionized water was added followed by approximately 0.162 ml 0.1 M aqueous hydrochloric acid. This mixture was heated for 1.5 hours at 65° C. and the resulting sol solution was cooled to room temperature.

Approximately 1 gram of 70 nm (15 m²/g) nanoparticulate zinc oxide obtained from Nanophase Technologies was dispersed in approximately 9 ml of deionized water using stirring and sonication in a bath sonicator. Approximately 1 ml of the 10% ZnO dispersion was added to about 2 ml of sol with sonication to such that was a ZnO to silicon ratio of about 1:2.5 by weight. Then about 100 μL of 1 M NH₄OH was added while being mixed and then the dispersion was allowed to stand until gelation occurred. The gelled monolith was then cured to form a template-containing xerogel by heating at 30° C. and slowly drying until the size of monolith remained constant, which took several days. The template-containing monolithic xerogel, which was opaque, was soaked in 0.1 M aqueous hydrochloric acid until it became translucent to transparent, which took about 24 hours. The residual acid and zinc ions were removed by soaking the monolith in deionized water. The template-free monolith was then removed from the water bath and allowed to dry.

The monolithic structure retained both its shape and size following the dissolution treatment. When the templates were removed the matrix became transparent, however, upon drying a translucent appearance reemerged. The translucent appearance is believed to be the result of the multiple light scattering and refractive index differences between the matrix silicate and the air filled nanopores throughout the monolithic structure.

### C. Example 3

### Silicate Monolith with Nanosized Functionalized Voids

1. Coated Templates

Approximately 4.3 ml ethanol (dried over 4 A molecular sieves) and 3-aminopropyltriethoxysilane 4.7 ml (20 mmol) were added to a round bottom flask under an inert atmosphere and stirring. About 0.262 ml deionized water followed by about 0.162 ml 0.1 M aqueous hydrochloric acid were added. The mixture was heated for about 1.5 hours at about 65° C. and the resulting sol solution was cooled to room temperature.

Approximately 8.5 ml of deionized water followed by approximately 1.5 grams of 70 nm (15 m²/g) nanoparticulate zinc oxide powder from Nanophase Technologies with vigorous stirring were added to another round bottom flask to form a slurry or dispersion. Approximately, 1.5 ml of the sol solution was added to the slurry followed by continued mixing for about 30 minutes to deposit a sol coating on the nanoparticles. Then, the slurry was centrifuged to separate the solids from the liquid. The separated solids were washed twice with a 1:1 mixture of ethanol and water to remove excess sol coating.

2. Monolith Preparation

Approximately 4.3 ml of ethanol (dried over 4 A molecular sieves) and 4.7 ml (21 mmol) of tetraethoxysilane were added to a round bottom flask under inert atmosphere and the solution was stirred. While continuing to stir the solution, approximately 0.262 ml deionized water was added followed by approximately 0.162 ml 0.1 M aqueous hydrochloric acid. This mixture was heated for 1.5 hours at 65° C. and the resulting sol solution was cooled to room temperature.

Approximately 1 gram coated of 70 nm (15 m²/g) nanoparticulate zinc oxide from Nanophase Technologies was dispersed in approximately 9 ml of deionized water using stirring and sonication in a bath sonicator. Approximately 1 ml of the 10% coated ZnO dispersion was added to about 2 ml of tetraethoxysilane sol with sonication to such that was a ZnO to silicon ratio of about 1:2.5 by weight. Then about 100 μL of 1 M NH₄OH was added while being mixed and then the dispersion was allowed to stand until gelation occurred. The gelled monolith was then cured to form a template-containing xerogel by heating at 30° C. and slowly drying until the size of monolith remained constant, which took several days. The template-containing monolithic xerogel, which was opaque, was soaked in 0.1 M aqueous hydrochloric acid until it became translucent to transparent, which took about 24 hours. The residual acid and zinc ions were removed by soaking the monolith in deionized water. The template-free monolith was then removed from the water bath and allowed to dry.

The functional coating left behind within the nanopores have similar structures to the shell materials described above except that the organic functionality is included as a substituent of the coating held within the matrix. Detection of accessible amino groups is performed using a ninhydrin or fluoresamine assay. In the case of the ninhydrin assay, organoamine functional coating components were identified and localized within the monolith by creating ninhydrin adducts with the amino groups on the coating. To this end, the dried template-removed monolith containing amino coated nanopores was soaked with 0.1 mM ninhydrin solution in ethanol. The monolith was removed from the solution and excess reagent dried from the surface. The monolith was then heated at 100° C. for 5 minutes until the monolith became a deep purple color indicating the formation of ninhydrin amine adducts. A control experiment using a monolith containing nanopores prepared without an amino coating and treated under the same experimental conditions failed to show any measureable color change. The experiment was extended by substituting fluorescamine as the indicator reagent. Once again treatment of both amine coated and uncoated monoliths with 0.01 mM fluorescamine reagent showed colorimetric reaction with monoliths containing only amine coated nanopores.

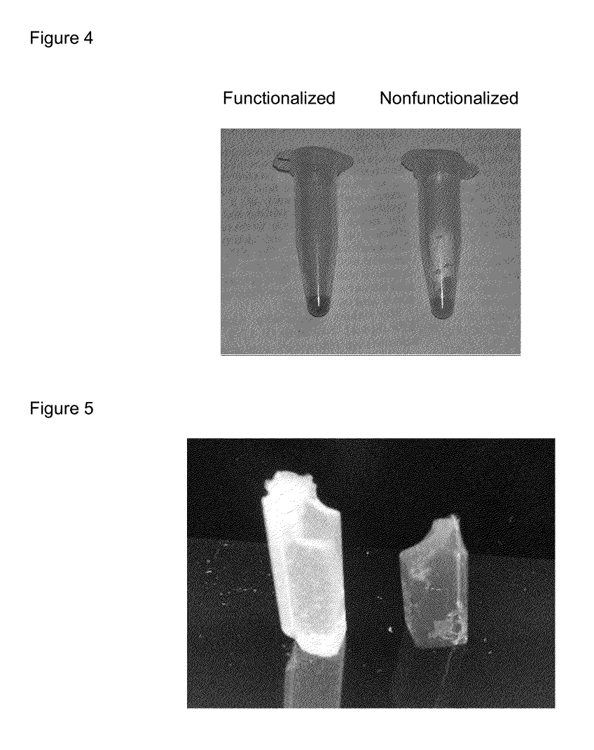

As shown in FIG. 4, the binding ability of shells with quaternary amine functionalized interior surfaces to bind anionic molecules dissolved in the appropriate solvent. In this case, the anionic molecules were Coomassie Brilliant Blue dye and the solvent was water. After being exposing the functionalized shell powder and comparative non-functionalized shell powder, they were washed with water and the remaining dye bound to the powder was assessed by spectroscopy.

### D. Example 4

### Secondary Chemical Functionalization of Nanopore Surface; Fluorescent Probe Molecules as Reporters for Nanopore Environment

1. Preparation of Tagged Nanotemplates

A silica sol was formed by stirring 2.3 g of 11 mmols of tetraethoxysilane, 0.6 g of 0.5 mmol dimethyldimethoxysilane, 0.9 g of 7.6 mmol trimethylmethoxysilane, and 56 mg of 0.2 mmol 4-aminobutyltriethoxysilane in 4.3 ml of dry ethanol under nitrogen. To the stirred solution was added 0.262 ml of deionized water and 0.163 ml of 0.1 M aqueous hydrochloric acid. The mixture was heated to 60° C. for 30 minutes and then 93 mg of 0.25 mmol isothiocyanofluorescein was added followed by continued heating for one hour forming an orange colored solution. The orange solution was added slowly to 10 grams of zinc oxide (average particle size 70 nm) dispersed in 30 ml of deionized water and then mixture was diluted with 60 ml of ethanol and subjected to high shear mixing to form an orange colored dispersion. The orange dispersion was mixed for 15 minutes and the solids were collected by centrifugation. The collected and coated zinc oxide was redispersed and washed three times with 1:1 deionized water:ethanol. The washed orange colored zinc oxide was dispersed in ethanol to 50% weight and stored in the dark.

2. Preparation of Mesoporous Fluorescent Tagged Silicates

To a round bottom flask was added 40 ml ethanol followed by 41.6 g of 0.2 mol tetraethoxysilane with stirring under nitrogen. The reaction was started by addition of 2.6 ml deionized water and 1.6 ml of 0.1 M aqueous hydrochloric acid followed by heating to 60° C. for 1.5 hours. The prepared sol resulted in a 15% by weight solution of silica which was used as the matrix precursor without further processing. Next, 1 mg of the 50% weight fluorescent tagged coated nanozinc oxide dispersion was mixed with 20 ml of the silica sol solution to produce a 0.017% by weight zinc oxide to silica loading. The dispersion was gelled by addition of 0.5 ml of 1M methanolic ammonium hydroxide followed by heating to 50° C. Following primary gelation, further curing of the aerogel was realized by heating until the remaining solvent was removed thereby forming silica monoliths comprising the fluorescent tagged templates. The cured gel was ground into a powder and then dispersed in 20 ml of deionized water. To the stirred dispersion was added 35 μl of 0.2 M aqueous H₂SO₄ solution dropwise (resulting in the dispersion comprising 6 μmol of H₂SO₄) to dissolve the zinc oxide templates. After dissolution, the solids, which were translucent, were collected by filtration and washed with excess deionized water to remove remaining acid and zinc ions until the pH of the wash solution was neutral. The solids were dried overnight at 50° C. and stored for future analysis.

Additionally, other substantially similar monoliths were prepared; one with non-tagged ZnO templates and one with the fluorescent tagged ZnO templates. The templates were dissolved from the monoliths in a substantially manner. As shown in FIG. 5, the monoliths were subjected a photographic comparison which shows that the monolith on the right (prepared with non-tagged nanotemplates) did not fluoresce when illuminated with a UV light, whereas the monolith on the left (prepared using nanotemplates tagged with fluorescein functional groups) did fluoresce. Thus, the fluorescein functionalized templates imparted the fluorescein functionality to the pores/voids of the monolith.

### E. Example 5

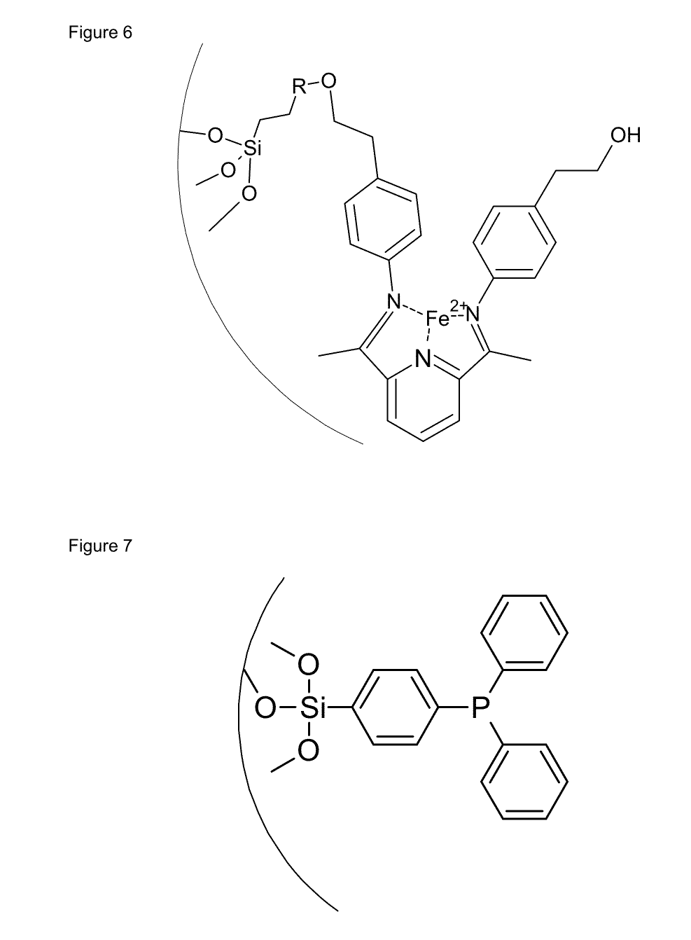

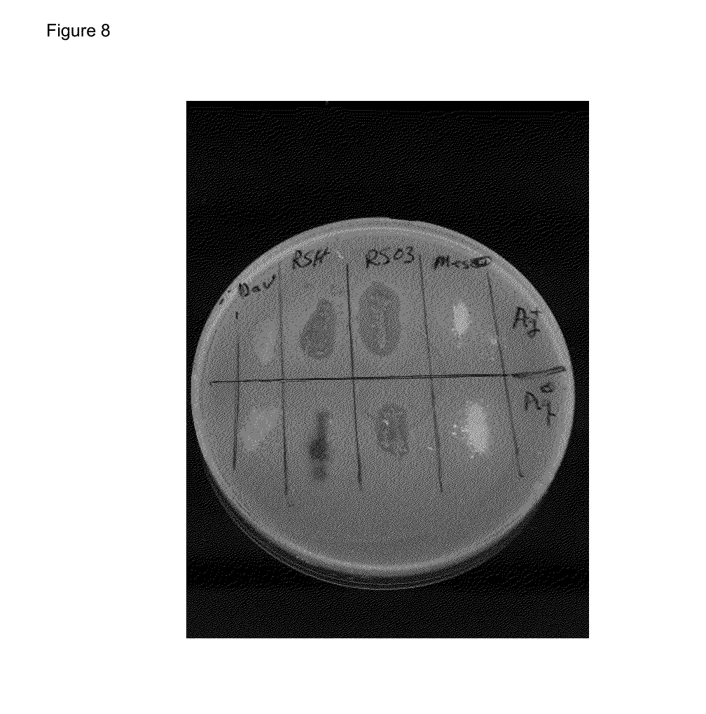

### Metal Ligating Functional Groups Added Before Dissolution of Templates; Preparation of Polysiloxane Linked 2,6-diethyl-4-hydroxyethylphenyliminopyridine Ligand Surfaces as Shown in FIG. 6

1. Ligand Synthesis

The diiminopyridine ligand was prepared essentially as described by Schmidt et al., J. Mol. Cat. 2002, 179, 155-173, which is incorporated by reference herein its entirety. Briefly, to a flame dried round bottom flask was added 68 mg of 1.2 mmol 4-aminophenethyl alcohol, 100 mg of 0.6 mmol 2,6-diacetylpyridine, and 10 mg of p-toluenesulfonic acid dissolved in 25 ml dry toluene with stirring under nitrogen. The reaction was heated to reflux and product water was removed using a Dean Stark trap. The reaction product was recovered by cooling the reaction to room temperature and washing the organic layer with aqueous sodium carbonate and then water. The organic layer was allowed to dry by evaporation and the residue was recrystallized from ethanol to afford yellow-green needles of 2,6-diethyl-4-hydroxyethylphenyliminopyridine.

2. Polysiloxane Linked Ligand Preparation

To a flame dried round bottom flask was added 10 ml of dry THF, 150 mg of 0.48 mmol 2,6-diethyl-4-hydroxyethylphenyliminopyridine, and 120 mg of 0.48 mmol propylisocyanatotrimethoxysilane. The solution was stirred for 2 hours at room temperature under nitrogen to form a polysiloxane linked ligand solution. The reaction mixture was used directly with no further purification for silica sol preparation.

3. Preparation of Coated Nanotemplate

To a round bottom flask is added 6 ml of ethanol followed by 5 ml of tetraethoxysilane, 5 ml of trimethylmethoxysilane, and 5 ml of the polysiloxane linked ligand silane solution. The reaction was stirred under nitrogen and initiated by addition of 0.48 ml of deionized water and 0.24 ml of 0.1 M aqueous hydrochloric acid. The reaction was heated to 60° C. for 1.5 hours and then cooled to room temperature. A slurry of nanosize zinc oxide was prepared by dispersing 10 grams of solids (average particle size 70 nm) into 50 ml of deionized water followed by 100 ml of ethanol. The slurry was mixed with high shear for 10 minutes and the cooled sol was added thereto and followed by continued high shear mixing for 30 minutes. The solids were then collected by centrifugation and washed three times, each with 3 volumes of ethanol. The final washed and coated zinc oxide was stored as a 50% weight dispersion in ethanol.

4. Preparation of Mesoporous Metal Ligand Silicates

To a round bottom flask was added 40 ml of ethanol followed by 41.6 g of 0.2 mol tetraethoxysilane with stirring under nitrogen. The reaction was started by addition of 2.6 ml of deionized water and 1.6 ml of 0.1 M aqueous hydrochloric acid followed by heating to 60° C. for 1.5 hours. The prepared sol resulted in a 15% by weight solution of silica which was used as the matrix precursor without further processing. Next, 2 grams of 50% weight ligand coated nanozinc oxide dispersion was mixed with 7 ml of silica sol solution to afford a 1:1 silica to zinc oxide mixture (weight percent basis). The dispersion was gelled by addition of 0.5 ml of 1 M methanolic ammonium hydroxide followed by heating to 50° C. Following primary gelation, further curing of the aerogel was performed by heating until remaining solvent was removed. The cured gel was ground into a powder and then dispersed in 10 ml of deionized water. To the stirred dispersion was added 7.5 mmol of H₂SO₄ as a 0.2 M aqueous solution (37.5 ml) dropwise to dissolve the zinc oxide templates. The solids (which were translucent) were collected by filtration and washed with excess deionized water to remove remaining acid and zinc ions until the pH of the wash solution was neutral. The solids were dried overnight at 50° C. and then dispersed in 10 ml of ethanol. A 10 mM solution of ferrous chloride in ethanol was added to the dispersion and stirred overnight. The solids, dark blue in color, were collected by filtration and washed with ethanol to removed unligated metal ions and the solids were dried and stored under nitrogen.

### F. Example 6

### Metal Ligating Functional Groups Added After Dissolution of Templates; Preparation of Polysiloxane Linked Triphenylphosphine Ligand Surfaces as Shown in FIG. 7

1. Preparation of Coated Nanotemplates

To a round bottom flask was added 4.3 ml of ethanol followed by 2.5 ml of tetraethoxysilane, and 7.7 ml of bromophenyltrimethoxysilane. The reaction was stirred under nitrogen and initiated by addition of 0.262 ml of deionized water and 0.163 ml of 0.1 M aqueous hydrochloric acid. The reaction was heated to 60° C. for 1.5 hours and then cooled to room temperature. A slurry comprising nanosized zinc oxide (average particle size 70 nm) was prepared by dispersing 10 grams of solids into 50 ml of deionized water followed by 100 ml of ethanol. The slurry was mixed with high shear for 10 minutes and 6 ml of the cooled sol was added to the slurry in one portion followed by continued high shear mixing for 30 minutes. The solids were collected by centrifugation and washed three times each with 3 volumes of ethanol. The final washed and coated zinc oxide was stored as a 50% weight dispersion in ethanol.

2. Preparation of Mesoporous Triphenylphosphine Silicates

To a round bottom flask was added 40 ml of ethanol followed by 41.6 g of 0.2 mol tetraethoxysilane with stirring under nitrogen. The reaction was started by addition of 2.6 ml of deionized water and 1.6 ml of 0.1 M aqueous hydrochloric acid followed by heating to 60° C. for 1.5 hours. The prepared sol afforded a 15% weight solution of silica, which was used directly as the matrix precursor without further processing. Next, 2 grams of 50% weight ligand coated nanozinc oxide dispersion was mixed with 7 ml of silica sol solution to afford a 1:1 silica to zinc oxide mixture (weight percent basis). The dispersion was gelled by addition of 0.5 ml of 1 M methanolic ammonium hydroxide followed by heating to 50° C. Following primary gelation, further curing of the aerogel was performed by heating until the remaining solvent was removed. The cured gel was ground into a powder and then dispersed in 10 ml of deionized water. To the stirred dispersion was added 7.5 mmol of H₂SO₄ as a 0.2 M aqueous solution (37.5 ml) dropwise to dissolve the zinc oxide templates. The translucent solids were collected by filtration and washed with excess deionized water to remove remaining acid and zinc ions until the pH of the wash solution was neutral. The silica solids were dispersed in 50 ml ethanol to which 2 grams of trimethylmethoxysilane and 0.2 ml 0.1 M HCl was added. The slurry was stirred at room temperature overnight following which the silica solids were collected by filtration and washed with excess ethanol. The silica solids were then dried at 50° C. overnight under high vacuum. The synthetic preparation of nanopore linked triphenylphosphine is adapted from the teachings of Ager et al. Chem. Comm. 1997, 2359-2360 which is incorporated by reference herein its entirety. Next, 1 gram of silica solids (0.0012 mmol of bromobenzene equivalent) were dried overnight at 50° C. at high vacuum and then dispersed in 10 ml of dry (DMF). To the slurry was added 0.3 mg (0.0013 mmol) chlorodiphenylphosphine, 0.012 mg (0.22 micromol) 1,2-bisdiphenylphosphinoethanedichloronickel, and 0.126 mg (0.0016 mmol) zinc metal. The reaction was stirred for overnight at 110° C. following which the solids were hot filtered and washed with 10 ml of DMF and stored under nitrogen. Next, 10 mg of solids were treated with a 10 mM DMF solution of ferrous chloride and stirred overnight. The solids were collected by filtration and washed with THF to remove unligated metal ions and the solids were dried and stored under nitrogen.

### G. Example 7

### Delivery of Biologically Active Agent; Silver/Silver Ion Nanopore Loading

1. Preparation of Coated Nanotemplate

A silica sol composed of 3.1 grams, 15 mmols tetraethoxysilane and 2.9 grams, 15 mmol of 3-mercaptopropyltrimethoxysilane was dissolved in 4.3 ml of dry ethanol and stirred under nitrogen. To the stirred solution was added 0.262 ml deionized water and 0.163 ml of 0.1 M aqueous hydrochloric acid. The mixture was heated to 60° C. for 1.5 hours. The sol solution was added slowly to 10 grams of zinc oxide (average particle size 70 nm) dispersed in 30 ml of deionized water and then diluted with 60 ml of ethanol with high shear mixing. The resulting dispersion was mixed for 15 minutes and then the solids were collected by centrifugation. The collected coated zinc oxide was redispersed and washed three times with 1:1 deionized water:ethanol and the resulting zinc oxide was dispersed in ethanol to 50% weight and stored.

2. Preparation of Mesoporous Thiol/Sulfate Silicates

To a round bottom flask was added 40 ml of ethanol followed by 41.6 g of 0.2 mol tetraethoxysilane with stirring under nitrogen. The reaction was started by addition of 2.6 ml of deionized water and 1.6 ml of 0.1 M aqueous hydrochloric acid followed by heating to 60° C. for 1.5 hours. The prepared sol afforded a 15% weight solution of silica which was used directly as the matrix precursor without further processing. Next, 2 grams of 50% weight thiol-substituted coated nanozinc oxide dispersion was mixed with 7 ml of silica sol solution affording a 1:1 ratio of zinc oxide to silica loading on a weight percent basis. The dispersion was gelled by addition of 0.5 ml of 1 M methanolic ammonium hydroxide followed by heating to 50° C. Following the primary gelation, further curing of the aerogel was performed by heating until the remaining solvent was removed. The cured gel was ground into a powder and then dispersed in 20 ml of deionized water. To the stirred dispersion was added 7.5 mmol of H₂SO₄ as a 0.2 M aqueous solution (37 ml) dropwise to dissolve the zinc oxide template. The solids (translucent) were collected by filtration and washed with excess deionized water to remove remaining acid and zinc ions until the pH of the wash solution was neutral. Half of the solids were dispersed to 50% weight and stored as thiol-substituted mesoporous silica in water whereas the other half of the material was dispersed in 5 ml of deionized water to which 5 ml of 30% aqueous H₂O₂ solution was added with stirring. The reaction was heated to 50° C. for 2 hours and cooled. The solids were collected by filtration and washed with water to remove residual peroxide. The solids were dispersed in water to 50% weight and stored as sulfate-substituted mesoporous silica.

3. Silver Ligation

To a first set of test tubes was added 1 ml of deionized water and 20 mg of 50% weight dispersion mesoporous solids—one containing thiol-substituted solids, one containing the sulfate-substituted solids, one containing Davisil silica (as a control), and one containing unsubstituted mesoporous silica. To the first set of test tubes was added 100 microliters of a 10 mM aqueous silver nitrate solution. The tubes were agitated for 30 minutes and the solids collected by centrifugation. The solids were then washed 3 times with 1 ml of aqueous 0.25 M sodium nitrate solution followed by 3 washes with 1 ml of deionized water. The washed solids were air dried and stored in the dark prior to testing. A second set of tubes containing the same solids, was subjected to a silver treatment and washing, followed by dispersing the solids in 1 ml of deionized water, followed by addition of 100 microliters of aqueous 1 mM ascorbate solution to reduce bound silver ion to silver metal. These solids were washed 3 times with 1 ml of deionized water. The washed solids were air dried and stored in the dark prior to testing.

4. Biological Challenge Testing

A Petri dish was prepared with LB agar and a lawn of log phase growing Pseudomonas fluorescens was applied by standard microbiological techniques. Next, 1 mg of each silver treated solid described above was applied in a uniform and separated line arranged in an array across the agar surface. The dish was incubated overnight at 30° C. and inspected for growth of the test organism. Clearing zones were observed for some of samples as shown in Table A thereby indicating inhibition of microbial growth, which is consistent for bacteriostasis or antimicrobial activity. FIG. 6 is photograph of the dish showing the results of Table A.

TABLE A
Antibacterial activity of silver bound silicates

| Sample | Clearing Zone |
|---|---|
| Davisil Ag+ | None |
| Davisil Ag | None |
| Mesopore Thiol Ag+ | Good 1-2 mm |
| Mesopore Thiol Ag | None |
| Mesopore Ag+ | None |
| Mesopore Ag | None |
| Mesopore Sulfate Ag+ | Large >2 mm |
| Mesopore Sulfate Ag | Modest 1 mm |

### H. Example 8

### Storage and Delivery Agent; Methane Binding and Release Study

1. Preparation of Coated Nanotemplate

To a stirred round bottom flask was added 114 ml of ethanol, 62 grams of 0.3 mol tetraethoxysilane, and 80 grams of 0.45 mol methyltriethoxysilane. The reaction was started by addition of 9.83 ml of deionized water followed by 6.1 ml of 0.1 M aqueous hydrochloric acid. The reaction was heated to 60° C. and allowed to proceed for 1.5 hours and then cooled to room temperature. Next, 280 grams of nano-zinc oxide powder (average particle size 70 nm) was dispersed in 600 ml of deionized water under high shear mixing and then diluted with 500 ml of ethanol. To the high sheared slurry, 112 ml of freshly prepared sol was slowly added followed by continued mixing for 30 minutes. The solids were collected by centrifugation and then washed with one volume of ethanol. The final washed solids were re-dispersed in ethanol to 50% weight.

2. Preparation of Methyl Substituted Mesoporous Silicates

To a stirred round bottom flask was added 315 ml of ethanol and 347 grams of 1.67 mol of tetraethoxysilane. The reaction was started by adding 22.5 ml of deionized water followed by 13.4 ml of 0.1 M aqueous hydrochloric acid. The reaction was heated to 60° C. for 1.5 hours and cooled to room temperature. Next, 200 grams of 50% weight methyl substituted zinc oxide dispersion was dispersed in the freshly prepared sol to afford 1:1 ratio of silica to zinc on a weight basis. The admixed slurry was gelled by addition of 25 ml of 1 M methanolic ammonium hydroxide and the reaction maintained at 50° C. until the material underwent gelation. The solid material was allowed to cure overnight at 50° C. and the resulting dried solid was ground to a coarse powder. The powder was dispersed in 500 ml water with stirring to which 0.65 mol of concentrated H₂SO₄ was added dropwise to dissolve the zinc oxide template. The translucent silicate was collected by filtration and washed with deionized water to remove residual zinc ions and the resulting solids were dried and then ground to a fine powder (−200 mesh).

3. Methane Binding and Release

To a glass sample tube was added 10 grams of methyl substituted mesoporous silicate. The silicate was degassed under high vacuum and then soaked with 3% methane in nitrogen. The tube was then purged with nitrogen and then attached to an inline gas analyzer. The tube was heated in a gradient between ambient and 100° C. with continuous nitrogen purge. Release of methane from the sample was continuously monitored during the elution process and the methyl substituted mesoporous silicate was found to release less than 20% of the bound methane over the tested temperature range. Control experiments in which Davisil silica gel or unsubstituted mesoporous silica served as test samples quantitatively released methane rapidly over the first 10° C. of the test range.

### I. Example 9

### Pigment Extender

1. Preparation of Coated Nanotemplates

To a stirred round bottom flask was added 114 ml of ethanol, 62 grams of 0.3 mol tetraethoxysilane, and 108 grams of 0.45 mol phenyltrimethoxysilane. The reaction was started by addition of 9.83 ml of deionized water followed by 6.1 ml of 0.1 M aqueous hydrochloric acid. The reaction was heated to 60° C. and allowed to proceed for 1.5 hours and then cooled to room temperature. Next, 280 grams of nano-zinc oxide powder (average particle size 70 nm) was dispersed in 600 ml of deionized water under high shear mixing and then diluted with 500 ml of ethanol. To the high sheared slurry, 112 ml of freshly prepared sol slowly added followed by continued mixing for 30 minutes. The solids were collected by centrifugation and washed with one volume of ethanol. The final washed solids were re-dispersed in ethanol to 50% weight.

2. Preparation of Phenyl Substitute Mesoporous Silicates

To a stirred round bottom flask was added 315 ml of ethanol and 347 grams of 1.67 mol tetraethoxysilane. The reaction was started by adding 22.5 ml of deionized water followed by 13.4 ml of 0.1 M aqueous hydrochloric acid. The reaction was heated to 60° C. for 1.5 hours and cooled to room temperature. Next, 200 grams of 50% weight phenyl-substituted zinc oxide dispersion was dispersed in the freshly prepared sol to afford a 1:1 ratio of silica to zinc on a weight basis. The admixed slurry was gelled by addition of 25 ml of 1 M methanolic ammonium hydroxide and the reaction maintained at 50° C. until the material underwent gelation. The solid material was allowed to cure overnight at 50° C. and the resulting dried solid was ground to a coarse powder. The powder was dispersed in 500 ml of water with stirring to which 0.65 mol of concentrated H₂SO₄ was added dropwise to dissolve the zinc oxide templates. The translucent silicate was collected by filtration and washed with deionized water to remove residual zinc ions and the resulting solids were dried and then ground to a fine powder (−200 mesh).

3. Pigment Binding to Phenyl Substituted Mesoporous Silicates

Next, 50 grams of phenyl-substituted mesoporous silica was dispersed 200 ml of mineral spirits with stirring to which 5 grams of quinoline yellow was dissolved and allowed to bind to the silicate. The solids were collected by filtration and washed with mineral spirits to remove unbound dye. The bright yellow solids were dried and the powder stored at room temperature. The process was repeated with Davisil silica gel and unsubstituted mesoporous silica; both showed poor binding of dye, which resulted in recovered solids continuing to release dye during the washing process and afforded a pale yellow solid upon drying.

### J. Example 10

### Heterogeneous Acid Catalyst

### 1. Preparation of Coated Nanotemplates

The preparation of trisubstituted imidazoles represent a test case to establish comparative performance of sulfate, phenyl substituted mesoporous silicates as functional heterogeneous acid catalysts. The functionalized silicate was prepared by coating a nano-zinc oxide (average particle size 70 nm) with a freshly prepared siloxane sol, embedding the template zinc oxide in a silica matrix, and removing the template.

Specifically, a silica sol comprising 0.82 grams of 4 mmol tetraethoxysilane, 1.96 grams of 10 mmol 3-mercaptopropyltrimethoxysilane, and 1.44 grams of 6 mmol phenyltrimethoxysilane was dissolved in 4.3 ml of dry ethanol and stirred under nitrogen. To the stirred solution was added 0.262 ml of deionized water and 0.163 ml of 0.1 M aqueous hydrochloric acid. The mixture was heated to 60° C. for 1.5 hours. The sol solution was added slowly to 10 grams of zinc oxide (average particle size 70 nm) dispersed in 30 ml of deionized water and then diluted with 60 ml of ethanol with high shear mixing. The resulting dispersion was mixed for 15 minutes and then the solids were collected by centrifugation. The coated zinc oxide pellet was redispersed and washed three times with 1:1 deionized water:ethanol and the resulting zinc oxide was dispersed in ethanol to 50% weight and stored.

### 2. Preparation of Mesoporous Sulfate/Phenyl Silicates

To a round bottom flask was added 40 ml of ethanol followed by 41.6 g of 0.2 mol tetraethoxysilane with stirring under nitrogen. The reaction was started by addition of 2.6 ml of deionized water and 1.6 ml of 0.1 M aqueous hydrochloric acid followed by heating to 60° C. for 1.5 hours. The prepared sol afforded a 15% weight solution of silica which is used directly as the matrix precursor without further processing. Next, 2 grams of 50% weight thiol/phenyl substituted coated nanozinc oxide dispersion was mixed with 7 ml of silica sol solution to afford a 1:1 ratio of zinc oxide to silica loading on a weight percent basis. The dispersion was gelled by addition of 0.5 ml of 1 M methanolic ammonium hydroxide followed by heating to 50° C. Following primary gelation, further curing of the aerogel was performed by heating until the remaining solvent was removed. The cured gel was ground into a powder and then dispersed in 20 ml of deionized water. To the stirred dispersion was added 7.5 mmol of H₂SO₄ as a 0.2 M aqueous solution (37 ml) dropwise to dissolve the zinc oxide templates. The translucent solids were collected by filtration and washed with excess deionized water to remove remaining acid and zinc ions until the pH of the wash solution was neutral. Half of the solids were dispersed in water to 50% weight and stored as thiol-substituted mesoporous silica whereas the other half of the material was dispersed in 5 ml of deionized water to which 5 ml of 30% aqueous H₂O₂ solution was added with stirring. The reaction was heated to 50° C. for 2 hours and cooled. The solids were collected by filtration and washed with water to remove residual peroxide. The solids were dispersed in THF to 50% weight and treated with 100 μl of concentrated H₂SO₄ and stirred for 30 minutes at room temperature. The solids were collected by filtration and washed with THF and dried overnight at 60° C.

### 3. Synthesis of 2-(4-nitrophenyl)-4,5-diphenyl-1H-imidazole

An adapted procedure from Maleki et. al., Inter. J. Org. Chem. 2012, 2, 93-99, which is incorporated by reference herein its entirety, was used to test the acid silicate catalysts. Davisil silica was prepared according to the reference and sulfate/phenyl mesoporous silica was used as prepared above. To a flame dried, stirred, round bottom flask under nitrogen was added 1 ml of acetic acid, 212 mg of 1 mmol benzyl, 151 mg of 1 mmol 4-nitrobenzaldehyde, and 500 mg of 6.5 mmol ammonium acetate. The flask was fitted with a reflux condenser containing 4 A molecular sieves and the reaction was heated to 100° C. The reaction was allowed to proceed up to 2 hours and cooled to room temperature. The reaction product was dissolved into 10 ml THF and any catalyst, if present, was removed by filtration. The organic phase was washed with aqueous bicarbonate and then deionized water. The organic layer was removed in vacuo to afford the crude product. Conversion and purity of the isolated product was determined by TLC. The sulfate/phenyl mesoporous silicate catalyst afforded a clean and near stoichiometric conversion of starting materials to products with no observed remaining starting materials in 30 minutes while sulfuric acid impregnated Davisil yielded approximately 70-80% yields in 2 hours with recovered starting materials. The uncatalyzed reaction showed less than 20% conversion with recovered starting materials over the 2 hour reaction time. The final product was recrystallized from ethanol to afford red cubic crystals.

### K. Example 11

### Matrix with Functionalized Void/Pores and Hybrid Component; Preparation of Mica Embedded, Phenyl Substituted Mesoporous Silicates

To a stirred round bottom flask was added 315 ml of ethanol and 347 grams of 1.67 mol tetraethoxysilane. The reaction was started by adding 22.5 ml of deionized water followed by 13.4 ml of 0.1 M aqueous hydrochloric acid. The reaction was heated to 60° C. for 1.5 hours and cooled to room temperature. Next, 100 grams of Fiesta pearl mica predispersed at 50% weight in ethanol and 200 grams of 50% weight phenyl-substituted zinc oxide dispersion were dispersed in the freshly prepared sol to afford 1:1:1 ratio of mica to silica to zinc on a weight basis. The admixed slurry was gelled by addition of 25 ml of 1M methanolic ammonium hydroxide and the reaction maintained at 50° C. until the material underwent gelation. The solid material was allowed to cure overnight at 50° C. and the resulting dried solid was ground to a coarse powder. The powder was dispersed in 500 ml of water with stirring to which 0.65 mol of concentrated H₂SO₄ was added dropwise to dissolve the zinc oxide templates. The translucent silicate was collected by filtration and washed with deionized water to remove residual zinc ions and the resulting solids were dried and then ground to a fine powder (−200 mesh). A test dispersion of 1% weight in water of the mica embedded mesoporous silicate displayed was as iridescent opal slurry. Preparation of a quinoline dye bound material using an equivalent procedure as described for phenyl substituted mesoporous silicate above afforded a bright yellow opalescent material that retained color on the material that would not bleed into the liquid medium (water dispersion).

Having illustrated and described the principles of the present invention, it should be apparent to persons skilled in the art that the invention can be modified in arrangement and detail without departing from such principles.

Although the materials and methods of this invention have been described in terms of various embodiments and illustrative examples, it will be apparent to those of skill in the art that variations can be applied to the materials and methods described herein without departing from the concept, spirit and scope of the invention. All such similar substitutes and modifications apparent to those skilled in the art are deemed to be within the spirit, scope and concept of the invention as defined by the appended claims.

What is claimed is:

1. A method of making a functionalized nanoporous structure, the method comprising:
contacting a templated matrix with an acid solution, wherein the templated matrix comprises:
(i) a matrix, which comprises a matrix component that comprises a first sol-based ceramic;
(ii) one or more nanosized templates within the matrix, wherein each nanosized template comprises a ZnO core and a coating on the core, wherein the coating comprises a second sol-based ceramic and, optionally, a first functional material; and
(iii) optionally, a hybrid component that comprises one or more particles of a composition different from that of the matrix within the matrix;
to dissolve the ZnO core(s) and form one or more nanosized pores, each of which being defined by the coating; and
contacting the coating(s) defining the nanosized pore(s) with a composition comprising a second functional material to bind all or a portion of the second functional material to the coating(s) defining the nanosized pore(s), wherein the contacting the coating(s) defining the nanosized pore(s) with the composition comprising the second functional material is optional if the coating(s) comprise(s) the first functional material;
thereby forming the functionalized nanoporous structure, which comprises the (a) matrix, (b) one or more functionalized nanosized pores within the matrix, wherein each functionalized nanosized pore is defined by the coating and, optionally, the second functional material, and (c) optionally, the hybrid component within the matrix.

2. The method of claim 1, wherein the first functional material is present in the coating.

3. The method of claim 2, wherein each functionalized nanosized pore is defined by the coating and the second functional material.

4. The method of claim 1, wherein the first functional material is not present in the coating.

5. The method of claim 1, wherein the hybrid component is present in the templated matrix.

6. The method of claim 2, wherein the hybrid component is present in the templated matrix.

7. The method of claim 6, wherein each functionalized nanosized pore is defined by the coating and the second functional material.

8. The method of claim 4, wherein the hybrid component is present in the templated matrix.

9. The method of claim 1, wherein the hybrid component is not present in the templated matrix.

10. The method of claim 2, wherein the hybrid component is not present in the templated matrix.

11. The method of claim 10, wherein each functionalized nanosized pore is defined by the coating and the second functional material.

12. The method of claim 4, wherein the hybrid component is not present in the templated matrix.

13. The method of claim 1, wherein:
the first and second sol-based ceramics are independently selected from the group consisting of a sol-based silicate, a sol-based aluminate, a sol-based aluminosilicate, a sol-based titanate, a sol-based zirconate, and combinations thereof; and
the acid solution comprises one or more acids selected from the group consisting of H₂SO₄, HNO₃, H₃PO₄ and HCl;
the first and second functional materials are independently selected from the group consisting of silanes, halosilanes, alkoxysilanes, organosilanes, organoalkoxysilanes, haloorganosilanes, polymeric alkoxysilanes, polymeric organoalkoxysilanes, and combinations thereof;
each core has a size that is in a range of about 20 nm to about 500 nm;
each coating has a thickness that is in a range of about 0.1 nm to about 2 nm; and
the hybrid component, if present, is at an amount in the range of about 5 to about 85 percent by weight of the matrix, and the matrix component is at an amount in the range of about 15 to about 95 percent by weight of the matrix; and the particles of the hybrid component comprise a hybrid material selected from the group consisting of alumina, titania, fumed silica, mica, and combinations thereof; and each particle of the hybrid component has a size in a range of about 50 nm to about 10 μm.

14. The method of claim 13, wherein:
the sol-based silicate is selected from the group consisting of an alkoxysilane, an organosilane, an alkoxyorganosilane, a halosilane, a haloorganosilane, an organoalkoxysilane polymer, and combinations thereof;
the sol-based titanates is selected from the group consisting of organotitanates, halotitanates, alkoxytitanates, and combinations thereof;
the acid is H₂SO₄ and it is at concentration that is in a range of about 0.05 M to about 0.5 M; and
the hybrid component, if present, is at an amount in the range of about 5 to about 75 percent by weight of the matrix, and the matrix component is at an amount in the range of about 25 to about 75 percent by weight of the matrix.

15. The method of claim 14, wherein:
the sol-based silicate is the alkoxysilane and it is selected from the group consisting of tetraethoxysilane, tetramethoxysilane, tetrapropoxysilane, and combinations thereof; and
the sol-based titanate is the alkoxytitanate and it is selected from the group consisting of tetraethoxytitanate, tetrabutoxytitanate, tetraisopropoxytitanate, and combinations thereof.

16. The method of claim 1, wherein:
each core has a size that is in a range of about 20 nm to about 150 nm; and
each particle of the hybrid component, if present, has a size in a range of about 100 nm to about 1 μm.

17. The method of claim 1, wherein:
each core has a size that is in a range of about 30 nm to about 80 nm; and
each particle of the hybrid component, if present, has a size in a range of about 100 nm to about 500 nm.

18. The method of claim 1, further comprising forming the templated matrix, which comprises:
incorporating the nanosized template(s) and the hybrid component, if present, within a liquid matrix precursor; and
curing the liquid matrix precursor incorporating the nanosized template(s) and the hybrid component, if present, thereby forming the templated matrix.

19. The method of claim 18, wherein the nanosized template(s), the hybrid component, or both the nanosized template(s) and the hybrid component further comprise an independently selected compatibilizer coating that allows the liquid matrix precursor to wet the nanosized template(s), the hybrid component, or both the nanosized template(s) and the hybrid component, and wherein each compatibilizer coating comprises a compatibilizer material independently selected from the group consisting of an organosilane, an alkoxyoranosilanes, a haloorganosilanes, and combinations thereof.

20. The method of claim 18, wherein the nanoporous structure is a shell, the hybrid component is not present in the templated matrix, and there is a ratio of nanosized templates to liquid matrix precursor that is in a range of about 1:50 to about 1:250 by weight.

21. The method of claim 18, wherein the nanoporous structure is a monolith that comprises a multiplicity of the functionalized nanosized pores; and
wherein the process further comprises placing the liquid matrix precursor incorporating the nanosized template(s) and the hybrid component, if present, in a monolith mold for curing, wherein there is a ratio of nanosized templates to liquid precursor that is in a range of about 1:100 to about 100:1 by weight.

22. The method of claim 18, wherein the nanoporous structure is particulate; and
wherein the process further comprises:
placing the liquid matrix precursor incorporating the nanosized template(s) and the hybrid component, if present, in a monolith mold for curing, wherein there is a ratio of nanosized templates to liquid precursor that is in a range of about 1:100 to about 100:1 by weight; and
grinding the monolith to form the particulate; and
wherein the particulate is subjected to the step of contacting the coating(s) defining the nanosized pore(s) with the composition comprising the second functional material, if said step is performed.

23. The method of claim 18, wherein the nanoporous structure is a film that comprises a multiplicity of the nanosized pores and the hybrid component is not present in the templated matrix; and
wherein the process further comprises placing the liquid matrix precursor incorporating the nanosized template(s) on a film-forming surface.

24. A functionalized nanoporous structure comprising:
a matrix that comprises a first sol-based ceramic; and
one or more functionalized nanosized pores within the matrix, wherein each functionalized nanosized pore is defined by (i) a coating that comprises a second sol-based ceramic and, optionally, a first functional material; and (ii) a second functional material bound to the coating, wherein the second functional material is optional if the coating comprises the first functional material; and
optionally, a hybrid component that comprises one or more particles of a composition different from that of the matrix.

25. The functionalized nanoporous structure of claim 24, wherein the first functional material is present in the coating.

26. The functionalized nanoporous structure of claim 25, wherein each functionalized nanosized pore is defined by the coating and the second functional material.

27. The functionalized nanoporous structure of claim 24, wherein the coating does not comprise the first functional material.

28. The functionalized nanoporous structure of claim 24, wherein the matrix comprises the hybrid component.

29. The functionalized nanoporous structure of claim 25, wherein the matrix comprises the hybrid component.

30. The functionalized nanoporous structure of claim 29, wherein each functionalized nanosized pore is defined by the coating and the second functional material.

31. The functionalized nanoporous structure of claim 27, wherein the matrix comprises the hybrid component.

32. The functionalized nanoporous structure of claim 24, wherein the matrix does not comprise the hybrid component.

33. The functionalized nanoporous structure of claim 25, wherein the matrix does not comprise the hybrid component.

34. The functionalized nanoporous structure of claim 33, wherein each functionalized nanosized pore is defined by the coating and the second functional material.

35. The functionalized nanoporous structure of claim 27, wherein the matrix does not comprise the hybrid component.

36. The functionalized nanoporous structure of claim 24, wherein:
the first and second sol-based ceramics are independently selected from the group consisting of a sol-based silicate, a sol-based aluminate, a sol-based aluminosilicate, a sol-based titanate, a sol-based zirconate, and combinations thereof; and
the first and second functional materials are independently selected from the group consisting of silanes, halosilanes, alkoxysilanes, organosilanes, organoalkoxysilanes, haloorganosilanes, polymeric alkoxysilanes, polymeric organoalkoxysilanes, and combinations thereof;
each functionalized nanosized pore has a size that is in a range of about 20 nm to about 500 nm;
the hybrid component, if present, is at an amount in the range of about 5 to about 85 percent by weight of the matrix, and the matrix component is at an amount in the range of about 15 to about 95 percent by weight of the matrix; and the one or more particles of the hybrid component comprise a hybrid material selected from the group consisting of alumina, titania, fumed silica, mica, and combinations thereof; and each particle of the hybrid component has a size in the range of about 50 nm to about 10 μm.

37. The functionalized nanoporous structure of claim 36, wherein:
the sol-based silicate is selected from the group consisting of an alkoxysilane, an organosilane, an alkoxyorganosilane, a halosilane, a haloorganosilane, an organoalkoxysilane polymer, and combinations thereof;
the sol-based titanates is selected from the group consisting of organotitanates, halotitanates, alkoxytitanates, and combinations thereof; and
the hybrid component, if present, is at an amount in the range of about 5 to about 75 percent by weight of the matrix, and the matrix component is at an amount in the range of about 25 to about 75 percent by weight of the matrix.

38. The functionalized nanoporous structure of claim 37, wherein:
the sol-based silicate is the alkoxysilane and it is selected from the group consisting of tetraethoxysilane, tetramethoxysilane, tetrapropoxysilane, and combinations thereof; and
the sol-based titanate is the alkoxytitanate and it is selected from the group consisting of tetraethoxytitanate, tetrabutoxytitanate, tetraisopropoxytitanate, and combinations thereof.

39. The functionalized nanoporous structure of claim 24, wherein:
each functionalized nanosized pore has a size that is in a range of about 20 nm to about 150 nm; and
each particle of the hybrid component, if present, has a size in a range of about 100 nm to about 1 μm.

40. The functionalized nanoporous structure of claim 24, wherein:
each functionalized nanosized pore has a size that is in a range of about 30 nm to about 80 nm; and
each particle of the hybrid component, if present, has a size in a range of about 100 nm to about 500 nm.

41. The functionalized nanoporous structure of claim 24, wherein the nanoporous structure is a shell and does not comprise the hybrid component.

42. The functionalized nanoporous structure of claim 24, wherein the nanoporous structure is a monolith that comprises a multiplicity of the functionalized nanosized pores.

43. The functionalized nanoporous structure of claim 24, wherein the nanoporous structure is particulate.

44. The functionalized nanoporous structure of claim 24, wherein the nanoporous structure is a film that comprises a multiplicity of the functionalized nanosized pores and does not comprise the hybrid component.
